(19) United States
(12) Patent Application Publication
(10) Pub. No.: US 2026/0121497 A1
(43) Pub. Date: Apr. 30, 2026

(54) METHOD FOR PRODUCING STATOR AND STATOR

(71) Applicant: AISIN CORPORATION, Kariya (JP)

(72) Inventors: Shunsuke KOYABU, Kariya-shi (JP); Yoshiki YAMAUCHI, Kariya-shi (JP); Hiroaki YABUI, Kariya-shi (JP); Ryohei SUMI, Kariya-shi (JP)

(73) Assignee: AISIN CORPORATION, Kariya (JP)

(21) Appl. No.: 19/361,645

(22) Filed: Oct. 17, 2025

(30) Foreign Application Priority Data
Oct. 31, 2024 (JP) 2024-192098
Aug. 4, 2025 (JP) 2025-129932

(51) Int. Cl. H02K 15/122; C25D 9/02; H02G 1/12; H02K 3/34; H02K 15/35

(52) U.S. Cl. CPC H02K 15/122; H02G 1/128; H02K 3/34; H02K 15/35; C25D 9/02

(57) ABSTRACT

A method for producing a stator includes: a coil preparation step of preparing a coil in which an insulating coating is formed on a conductor; a stator core preparation step of preparing a stator core around which the coil is wound; an insulating coating peeling step of peeling off the insulating coating at a portion of the coil to be welded; a carbonization step of carbonizing a surface of an end portion of the insulating coating on a side facing conductor exposed by the peeling; a coil arrangement step of arranging the coil on the stator core; a welding step of welding the conductors exposed by the peeling in a plurality of the coils; and an electrodeposition coating step of performing electrodeposition coating on the exposed conductor and the carbonized surface of the insulating coating in each of the plurality of coils using a resin material.

### CROSS REFERENCE TO RELATED APPLICATIONS

This application is based on and claims priority under 35 U.S.C. § 119 to Japanese Patent Applications 2024-192098, filed on Oct. 31, 2024, and 2025-129932, filed on Aug. 4, 2025, the entire content of which is incorporated herein by reference.

### TECHNICAL FIELD

This disclosure relates to a method for producing a stator and a stator.

### BACKGROUND DISCUSSION

In the related art, a stator produced by winding a coil around a stator core is known. The wound coil is divided into a plurality of segments, and the segments are welded to each other to form an electric circuit of the coil into a predetermined circuit. The coil is usually covered with an insulating coating, but the insulating coating at a portion to be welded is peeled off. After the welding is performed, a conductor of the coil is covered with an insulating member so as not to be exposed. Electrodeposition coating is known as a technique for performing the covering with the insulating member (see, for example, JP 2014-180144A (Reference 1)).

In the technique in the related art, an electrodeposited coating obtained by the electrodeposition coating may not have sufficient adhesion to the insulating coating. Specifically, although the electrodeposited coating is formed on the conductor and the insulating member near the conductor by the electrodeposition coating, adhesion of the electrodeposited coating to the insulating coating is not sufficient since the electrodeposited coating is not electrically connected to the insulating coating that is the insulating member. Therefore, the electrodeposited coating may peel off at a boundary between the insulating coating present before welding and the electrodeposited coating formed by the electrodeposition coating after welding. On the other hand, it is possible to increase a thickness of the electrodeposited coating by increasing a voltage or increasing a time during the electrodeposition coating, but even in this case, the adhesion of the electrodeposited coating to the insulating coating is not sufficient, and the increase in the thickness of the electrodeposited coating leads to an increase in size of a stator, a decrease in cooling performance, and an increase in material cost.

A need thus exists for a technique which is not susceptible to the drawback mentioned above.

### SUMMARY

According to an aspect of this disclosure, a method for producing a stator includes: a coil preparation step of preparing a coil in which an insulating coating is formed on a conductor; a stator core preparation step of preparing a stator core around which the coil is wound; an insulating coating peeling step of peeling off the insulating coating at a portion of the coil to be welded; a carbonization step of carbonizing a surface of an end portion of the insulating coating on a side facing the conductor exposed by the peeling; a coil arrangement step of arranging the coil on the stator core; a welding step of welding the conductors exposed by the peeling in a plurality of the coils; and an electrodeposition coating step of performing electrodeposition coating on the exposed conductor and the carbonized surface of the insulating coating in each of the plurality of coils using a resin material.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a stator;

FIG. 2 is a diagram showing a segment coil;

FIG. 3 is a flowchart showing an example of a method for producing a stator;

FIGS. 4A, 4B, and 4C are cross-sectional views of an enameled wire cut parallel to a longitudinal direction;

FIGS. 5A and 5B are cross-sectional views of the enameled wire cut parallel to the longitudinal direction; and

FIGS. 6A, 6B, and 6C are cross-sectional views of the enameled wire cut parallel to the longitudinal direction.

### DETAILED DESCRIPTION

Here, an embodiment disclosed here will be described in the following order. (1) Configuration of Stator: (2) Method for Producing Stator: (3) Other Embodiments:

### (1) Configuration of Stator

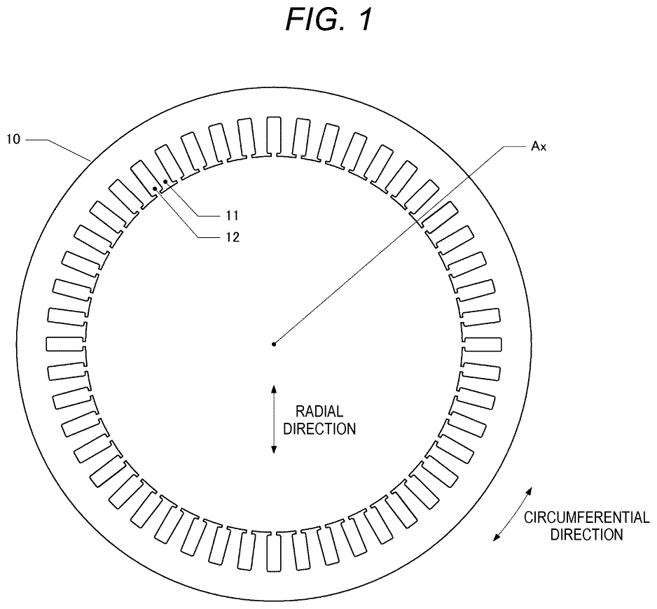

FIG. 1 is a plan view of a stator core 10 constituting a stator according to the present embodiment. The stator core 10 is an annular member, and FIG. 1 shows a state in which the stator core 10 is viewed along a center axis Ax of a ring formed by the stator core 10. A rotor (not shown) is disposed inside the ring formed by the stator core 10. The rotor is a member that rotates with the center axis Ax of the ring formed by the stator core 10 as a rotation axis. In the present specification, a direction parallel to the center axis Ax is referred to as an axial direction, a direction perpendicular to the center axis Ax is referred to as a radial direction, and a rotation direction about the center axis Ax is referred to as a circumferential direction. In the radial direction, a direction away from the center axis Ax is referred to as a radial outer side, and a direction approaching the center axis Ax is referred to as a radial inner side.

The stator core 10 includes a plurality of teeth 11 arranged in the circumferential direction and a plurality of slots 12 formed between the teeth 11 in the circumferential direction. In the present embodiment, the teeth 11 are portions each protruding from the radial outer side toward the radial inner side. The teeth 11 are formed at regular intervals in the circumferential direction on an entire inner circumference of the stator core 10. The number of teeth 11 may be any number. In the present embodiment, a cross-sectional shape of each of the teeth 11 in a direction perpendicular to the axial direction is the same at any position in the axial direction. Therefore, the tooth 11 is a portion that protrudes from the radial outer side toward the radial inner side in the radial direction and extends in the axial direction in a state where the cross-sectional shape in the direction perpendicular to the axial direction is the same.

A space formed between the teeth 11 in the circumferential direction is the slot 12. A coil is wound around the tooth. When the coil is wound around the tooth 11, the coil is in a state of being accommodated in the slot 12. The number of coils accommodated in the slot 12 and arranged in the radial direction is not limited, and may be any number.

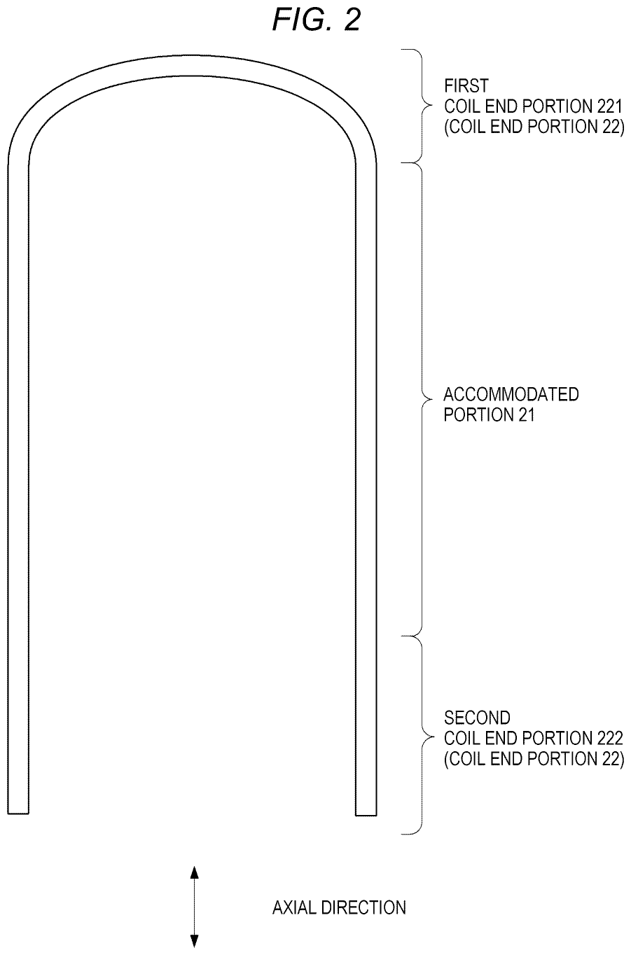

In the present embodiment, the coil is shaped in advance so as to be assembled to the stator core 10. A plurality of the shaped coils are assembled to the stator core 10. In the present embodiment, each of the plurality of coils is referred to as a segment coil. FIG. 2 is a diagram showing the segment coil. The segment coil is formed by bending a coil material having a predetermined length. The segment coil is assembled to the stator core 10 by inserting both ends into the slot 12 of the stator core 10. Therefore, FIG. 2 shows a state close to a state in which the segment coil is viewed in the radial direction when the segment coil is assembled to the stator core 10.

The coil material is, for example, an enameled wire, and copper as a conductor is covered with an insulating coating. The insulating coating may be a material that prevents conduction between the coils, and is, for example, an enamel resin made of polyamide-imide or the like. In the present specification, the coil is a rectangular wire, but a shape of a cross section perpendicular to a longitudinal direction of the coil is not limited.

The segment coil includes two accommodated portions 21 respectively accommodated in two slots 12, and coil end portions 22 protruding in the axial direction from end surfaces of the stator core 10. The coil end portions 22 include a first coil end portion 221 that is a portion extending from one of the accommodated portions 21 to the other of the accommodated portions 21 and connecting both of the accommodated portions 21, and a second coil end portion 222 that is a portion present on an opposite side to the first coil end portion in the axial direction and extending from each of the two accommodated portions 21.

Each of the accommodated portion 21 is a linear portion having a length corresponding to a length of the stator core 10 in the axial direction. Two accommodated portions 21 are formed in one segment coil, and are portions extending in the axial direction in a state of being parallel to each other. The first coil end portion 221 and the second coil end portion 222 are portions that extend in opposite directions in the axial direction from the accommodated portion 21.

The second coil end portion 222 is a portion extending linearly from the accommodated portion 21, and a tip end is a portion where the second coil end portions 222 are welded to each other. The first coil end portion 221 is a portion that extends from one of the accommodated portions 21 to the other of the accommodated portions 21 and connects both of the accommodated portions 21. That is, the first coil end portion 221 extends in the axial direction and the circumferential direction from a contact portion 21a for each of the two accommodated portions 21, and is connected at a center portion of the accommodated portions 21 in the circumferential direction.

In the present embodiment, after the plurality of segment coils are assembled to the stator core 10, the second coil end portions 222 are bent, and end portions of the second coil end portions 222 of different segment coils are brought into contact with each other. In this state, the segment coils form a predetermined circuit by welding the end portions of the second coil end portions 222 to each other, and the coil is in a state of being wound around the stator core 10.

### (2) Method for Producing Stator

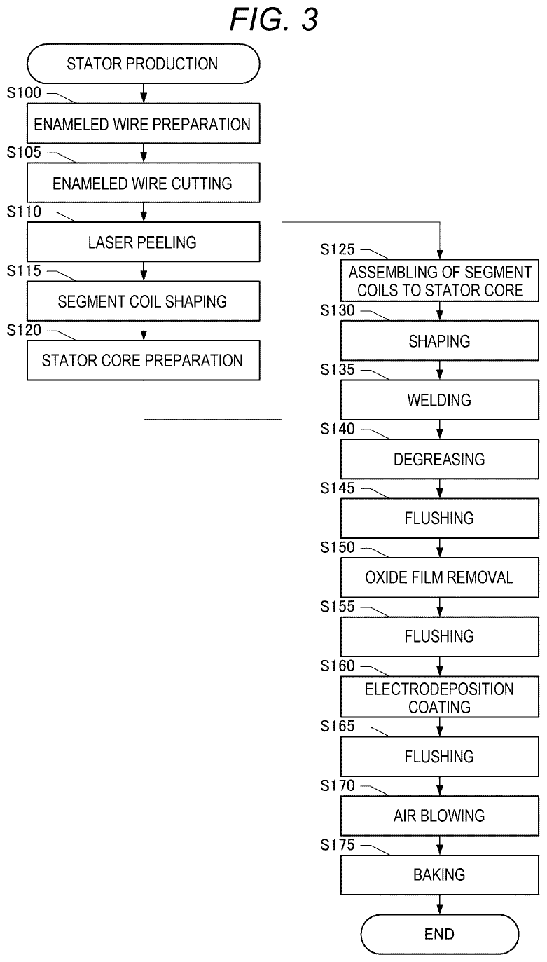

Next, a method for producing the stator according to the present embodiment will be described. FIG. 3 is a flowchart showing an example of the method for producing the stator. In the method for producing the stator, first, the enameled wire is prepared (step S100). Here, it is assumed that a linear enameled wire is prepared. For example, if the enameled wire is stored in a state of being wound around a roll, a necessary amount of the enameled wire is taken out and shaped into a linear shape.

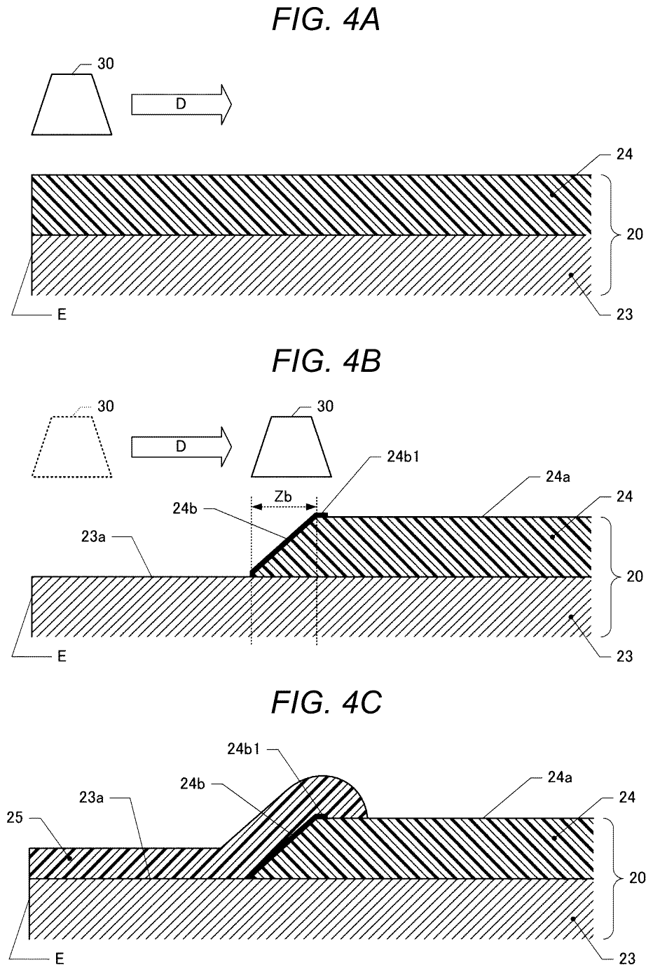

Next, the enameled wire is cut (step S105). That is, the enameled wire is cut to have the same length as a length of one segment coil. A plurality of the cut enameled wires are prepared. In the present embodiment, steps S100 and S105 described above correspond to a coil preparation step. FIG. 4A shows a cross-sectional view of an enameled wire 20 cut parallel to the longitudinal direction. The enameled wire 20 includes a conductor 23 and an insulating coating 24 covering an outer surface of the conductor 23. In the drawings of the present specification, some parts are emphasized for easy understanding. For example, a thickness or the like of the insulating coating 24 may be shown thicker than an actual thickness.

Next, laser peeling is performed (step S110). In the present embodiment, a laser output device is prepared in advance. The laser output device is a device that irradiates the insulating coating 24 with a laser, and can heat the insulating coating 24 by the laser to remove the insulating coating 24. A type of the laser, an output method, a mode of the device, and the like are not limited as long as the laser can peel off the insulating coating 24. When the laser output device irradiates the insulating coating 24 with the laser for a predetermined time or more, the insulating coating 24 is peeled off.

FIG. 4A schematically shows a laser output unit 30 of the laser output device. The insulating coating 24 is irradiated with the laser output from the laser output unit 30. When a time for which the same position is irradiated with the laser is equal to or longer than a predetermined time, the insulating coating 24 at the position is entirely removed. In the present embodiment, the laser output unit 30 moves from an end portion E side of the segment coil along the longitudinal direction of the segment coil as indicated by an arrow D, and peels off the insulating coating 24 in a predetermined range. FIG. 4B shows a state in which the insulating coating 24 in the predetermined range is peeled off.

In this manner, the portion where the insulating coating 24 is peeled off is a portion where the coils are to be welded to each other. Therefore, in the present embodiment, step S110 corresponds to an insulating coating peeling step. Further, in the present embodiment, a carbonization step is also performed in a process of the laser peeling. The carbonization step is a step of carbonizing a surface of an end portion of the insulating coating 24 on a side facing conductor 23 exposed by the peeling. The carbonized end portion is a region present between a surface 23a of the conductor 23 and a surface 24a of the insulating coating 24 at a boundary between the conductor 23 and the insulating coating 24. In FIG. 4B, the end portion is shown as an end portion Zb.

Specifically, when an irradiation time of the laser is shorter than a predetermined time for peeling off the insulating coating 24, the insulating coating 24 remains on the surface of the conductor 23 without being completely peeled off. Since the laser heats the insulating coating 24, when not peeled off, the insulating coating 24 gets to a state of being carbonized by carbon contained in the insulating coating 24. In FIG. 4B, the carbonized portion on the surface of the insulating coating 24 is shown as a carbonized portion 24b.

Further, in the present embodiment, the surface of the insulating coating 24 connecting the surface of the conductor 23 and the surface of the insulating coating 24 is carbonized at the boundary between the conductor 23 exposed by the peeling and the insulating coating 24. That is, an output intensity and the irradiation time of the laser are set such that the carbonized portion 24b is formed from the surface 23a of the conductor 23 to the surface 24a of the insulating coating 24 at the boundary between the conductor 23 and the insulating coating 24.

In the example shown in FIG. 4B, immediately below a point where the movement of the laser output unit 30 in the direction of the arrow D ends, a difference occurs in a degree of peeling of the insulating coating 24, and a peeling amount gradually decreases from the end portion E side toward an opposite side of the end portion E. That is, at the end portion Zb shown in FIG. 4B, a thickness of the insulating coating 24 gradually increases toward the opposite side of the end portion E. As described above, although the peeling amount of the insulating coating 24 varies depending on the position, the surface of the insulating coating 24 is formed such that carbonization is performed at all portions. That is, the output intensity and the irradiation time of the laser output from the laser output unit 30 are adjusted such that the surface of the insulating coating 24 is carbonized immediately below the position where the movement of the laser output unit 30 in the direction of the arrow D ends, and the carbonized portion is formed over the entire surface at least at the end portion Zb. In the example shown in FIG. 4B, an end portion 24b1 of the carbonized portion 24b extends beyond the end portion Zb where an inclined surface is formed in the insulating coating 24, and reaches a portion where the surface 24a of the insulating coating 24 is parallel to the surface 23a of the conductor 23.

As described above, in the present embodiment, the insulating coating 24 is peeled off by the laser. Therefore, the insulating coating 24 in a desired region can be easily peeled off with a simple configuration. Further, in the present embodiment, the laser used in the carbonization step and the insulating coating peeling step is continuously generated by the same device. That is, the carbonization step is also executed in parallel at an end of the insulating coating peeling step. Therefore, as compared with a configuration in which the carbonization step and the insulating coating peeling step are executed as separate steps, both steps can be easily executed and can be executed at high speed.

When the laser peeling is performed, next, segment coil shaping is performed (step S115). The segment coil shaping is a step of processing the enameled wire cut to the length of the segment coil in step S105 to shape the enameled wire into a shape of the segment coil. When the segment coil shaping is performed, each linear enameled wire becomes a segment coil having a shape shown in FIG. 2. Step S115 corresponds to the coil preparation step.

Next, the stator core 10 is prepared (step S120). Various known methods may be used to prepare the stator core 10. Typically, the stator core 10 is prepared by preparing and stacking a plurality of electromagnetic steel sheets shaped into a predetermined shape. In the present embodiment, step S120 corresponds to a stator core preparation step.

Next, the segment coils are assembled to the stator core 10 (step S125). That is, the plurality of segment coils shaped in step S115 are inserted into the slots 12 at predetermined positions in the stator core 10 prepared in step S120. When the assembly is performed, the second coil end portion 222 protrudes on one side in the axial direction of the stator core 10, and the first coil end portion 221 is disposed on the other side in the axial direction.

Next, the end portions of the segment coils are shaped so as to be weldable (step S130). That is, the second coil end portion 222 is bent such that the end portions of the segment coils to be connected come into contact with each other. In the present embodiment, steps S125 and S130 correspond to a coil arrangement step.

Next, welding is performed (step S135). That is, the end portions of the segment coils are welded to each other. In the present embodiment, step S135 corresponds to a welding step. Next, degreasing, flushing, and oxide film removal are performed (steps S140, S145, and S150), and the flushing is further performed (step S155). Various known methods may be applied to the degreasing, the flushing, and the oxide film removal. For example, the degreasing is performed using a chemical or the like that can decompose oil that may adhere to the surface of the segment coil or the stator core. The oxide film removal is performed, for example, by decomposing an oxide film formed on the surface of the conductor 23 using an acidic liquid such as sulfuric acid.

Next, electrodeposition coating is performed (step S160). In the present embodiment, step S160 corresponds to an electrodeposition coating step. The electrodeposition coating may be a known method. For example, a container is prepared in which a solvent for dissolving a water-soluble paint to be an electrodeposited coating is stored. In the present embodiment, the water-soluble paint is made of a resin material. In addition, the portion welded in step S135 and the portion including the conductor 23 exposed by the peeling are immersed in the solvent, and a current flows through electrodes. Then, the current flowing between the electrodes or a voltage between the electrodes is controlled for a predetermined time to get to a predetermined state. As a result, an electrodeposited coating (resin coating) made of a resin material is formed on the portion where the current flows, that is, the welded portion, the surface 23a of the exposed conductor 23, and a surface of the carbonized portion 24b.

FIG. 4C is a diagram showing an example after an electrodeposited coating 25 is formed. FIG. 4C does not show the welded portion. Since the electrodeposited coating 25 is formed on the portion where the current flows, the electrodeposited coating 25 is formed not only on the surface of the conductor 23 but also on the surface of the carbonized portion 24b. Since the carbonized portion 24b is formed from the surface 23a of the conductor 23 to the surface 24a of the insulating coating 24 as described above, the electrodeposited coating 25 is formed from the surface 23a of the conductor 23 to the surface 24a of the insulating coating 24. Therefore, the electrodeposited coating 25 can be formed on the end portion Zb of the conductor 23 and the insulating coating 24, and adhesion of the electrodeposited coating 25 to the insulating coating 24 and the conductor 23 can be increased.

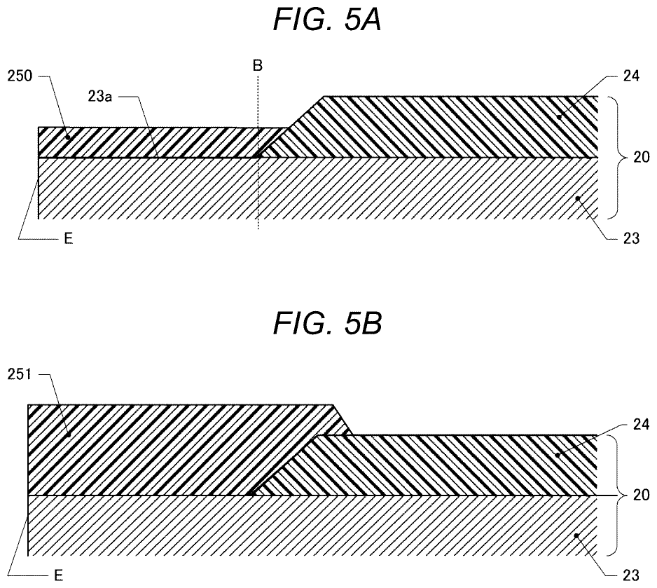

FIGS. 5A and 5B are diagrams for comparing the electrodeposited coating 25 according to the present embodiment with electrodeposited coating 250, 251 formed without using the carbonized portion 24b. FIG. 5A shows an example in which the electrodeposited coating 250 is formed so as to have a sufficient thickness for insulating the surface 23a of the conductor 23. As in the present example, even if the electrodeposited coating 250 is formed so as to have a sufficient thickness for insulating the surface 23a of the conductor 23, a thickness of the electrodeposited coating 250 is smaller near a boundary B between the conductor 23 and the insulating coating 24 than in other portions. In addition, the thickness of the insulating coating 24 is also smaller than in other portions. Therefore, in the example shown in FIG. 5A, the electrodeposited coating 250 and the insulating coating 24 are easily peeled off at the boundary B.

However, in the present embodiment, as shown in FIG. 4C, the electrodeposited coating 25 is formed on the surface of the carbonized portion 24b formed from the surface 23a of the conductor 23 to the surface 24a of the insulating coating 24. Therefore, a portion where the thickness of the insulating coating 24 is smaller is covered with the electrodeposited coating 25, and the electrodeposited coating 25 and the insulating coating 24 are less likely to be peeled off from the boundary B.

Further, by increasing a thickness of the electrodeposited coating 251 by, for example, increasing a time for the electrodeposition coating, as shown in FIG. 5B, it is possible to cover the portion where the thickness of the insulating coating 24 is smaller with the electrodeposited coating 251. However, when the carbonized portion 24b is not present, since no current flows in the end portion Zb during the electrodeposition coating, the adhesion of the electrodeposited coating 251 to the insulating coating 24 is weaker than that in a portion formed as a result of the current flowing. Therefore, the electrodeposited coating 251 and the insulating coating 24 are easily peeled off at the boundary. Further, in the example shown in FIG. 5B, the time for the electrodeposition coating increases, an amount of the water-soluble paint used to form the electrodeposited coating 251 increases, resulting in an increase in cost. However, according to the present embodiment, the portion where the thickness of the insulating coating 24 is smaller can be covered with the electrodeposited coating 25 without causing such an increase in cost, and the adhesion of the electrodeposited coating 25 to the insulating coating 24 and the conductor 23 can be increased.

Further, the carbonized portion 24b is formed by heating with a laser, and since carbonization generally proceeds irregularly at each position of the surface, surface roughness is rougher than that of the surface 23a of the conductor 23. When the surface roughness is rough and a sharp portion and a portion protruding in a spherical shape are present, an electric field is more likely to concentrate during the electrodeposition coating as compared with the flat surface 23a of the conductor 23. Therefore, the electrodeposited coating 25 on the surface of the carbonized portion 24b has a larger film thickness than the electrodeposited coating 25 on the surface 23a of the conductor 23. Therefore, in the present embodiment, a film thicker than that on the surface 23a of the conductor 23 can be formed on the end portion Zb of the conductor 23 and the insulating coating 24, and a possibility that the electrodeposited coating 25 is peeled off at the end portion Zb in a use process can be reduced.

Further, in the present embodiment, the carbonized portion 24b is formed from the surface 23a of the conductor 23 to the surface 24a of the insulating coating 24. Since the electrodeposited coating 25 is formed around the end portion 24b1 of the carbonized portion 24b, an end portion of the electrodeposited coating 25 on the opposite side of the end portion E reaches the surface 24a of the insulating coating 24. That is, according to the present embodiment, the electrodeposited coating 25 is formed so as to reach the surface 24a of the insulating coating 24, where the carbonized portion 24b is not present, continuously from the surface of the carbonized portion 24b. Therefore, a portion where the thickness of the insulating coating 24 is smaller is covered with the electrodeposited coating 25, and the electrodeposited coating 25 reaches a portion where the thickness of the insulating coating 24 is constant. Therefore, it is possible to prevent the insulating coating 24 from peeling off from the portion where the thickness is smaller.

When the electrodeposition coating is performed, the flushing and air blowing are performed (steps S165 and S170), and baking is performed (step S175). For the flushing and the air blowing, various known methods can be adopted. The air blowing may be performed to remove water, unwanted substances, and the like. For the baking, various known methods can be adopted as long as the solvent is volatilized from the electrodeposited coating 25 obtained by the electrodeposition coating and the electrodeposited coating 25 can be fixed to the surface 23a of the conductor 23 and the surface of the carbonized portion 24b.

### (3) Other Embodiments

The above embodiment is an example of carrying out this disclosure, and various other embodiments can be adopted. Further, in the method for producing a stator, an order of interchangeable steps may be changed, and a step that can be omitted may not be executed. For example, an order of the cutting of the enameled wire in step S105 and the laser peeling in step S110 may be reversed. In this case, by cutting the enameled wire at a center of a portion subjected to the laser peeling, the insulating coating peeling step for two segment coils is implemented by a common step. Further, the degreasing in step S140, the flushing in steps S145, S155, and S165, the oxide film removal in step S150, the air blowing in step S170, and the like can be omitted unless necessary.

The coil preparation step may be a step of preparing a coil in which an insulating coating is formed on a conductor. A shape and mode of the coil are not limited, but the coil may be in a state of being capable of winding around the stator core in the coil preparation step. Therefore, the coil may be in a state of being wound around a core, may be in a state of extending linearly, or may be in a state of the segment coil. In any state, if the segment coil is inserted into the stator core, the segment coil is shaped into a segment shape in the coil preparation step. If the coil is wound without using a segment, the coil preparation step may not include the shaping into the segment shape.

The conductor may be any conductor through which a current flows by a voltage applied to the coil, and copper, aluminum, or the like can be used. When the stator core is used as a motor, the insulating coating may be any coating that can insulate the coils from each other to prevent conduction therebetween, and examples of the insulating coating include an enamel coating.

The stator core preparation step may be a step of preparing a stator core around which the coil is wound. That is, in a configuration in which a coil is wound to form a stator of a rotary electric machine, a stator core having a portion around which the coil is wound may be prepared. A shape of the stator core is not limited, but is typically an annular member including a plurality of teeth arranged in the circumferential direction and a plurality of slots formed between the teeth in the circumferential direction.

The insulating coating peeling step may be a step of peeling the insulating coating at a portion where the coils are welded to each other. Since the welding is performed so as to join the conductors in a state where the insulating coating is not present, the insulating coating is peeled off at least at a portion to be welded. Since the electrodeposited coating is formed by the electrodeposition coating on a remaining un-welded portion, the insulating coating around the portion to be welded may be peeled off together with the portion to be welded.

The method for peeling off the insulating coating is not limited to laser. For example, the peeling may be mechanically performed by applying a force generated by a peeling member to the insulating coating. In this case, after the peeling of the insulating coating, a surface of an end portion of the insulating coating on a side facing the conductor exposed by the peeling is carbonized.

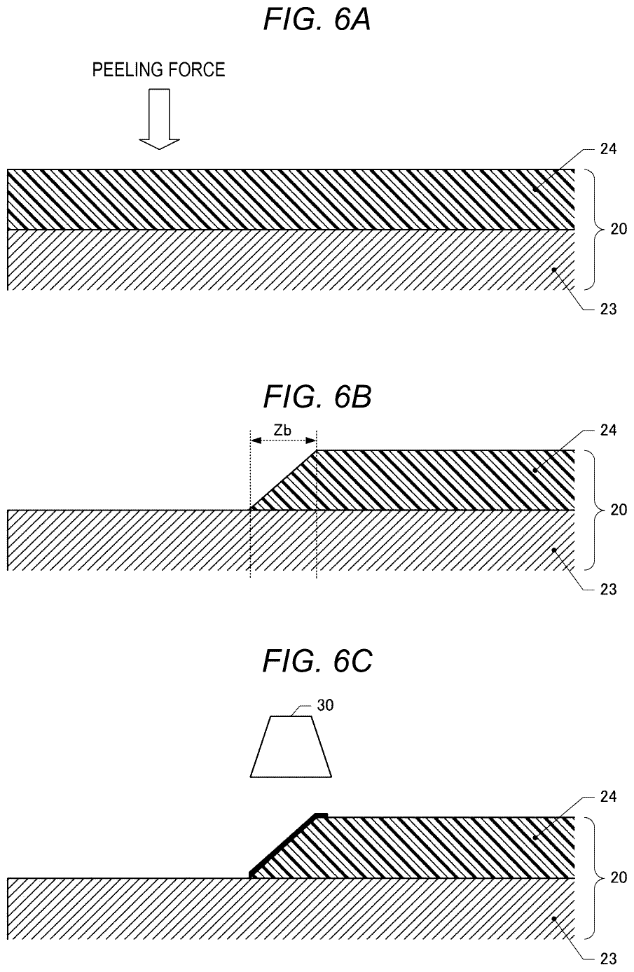

FIGS. 6A, 6B, and 6C are diagrams showing a state in which the mechanical peeling is performed. In this case, in the flowchart shown in FIG. 3, step S110 is replaced with an insulating coating peeling step of performing the mechanical peeling and the carbonization step. FIG. 6A shows the enameled wire 20 before peeling. A peeling member (not shown) is pressed against the enameled wire 20 such that a peeling force acts on a predetermined portion of the enameled wire 20. As a result, the insulating coating 24 is peeled off. By performing the peeling in a predetermined range, as shown in FIG. 6B, the enameled wire 20 in a state in which the insulating coating 24 is partially peeled off is formed.

Thereafter, the carbonization step of carbonizing the surface of the insulating coating 24 at the end portion Zb is performed. This step can be performed by, for example, the laser. For example, when the end portion Zb is irradiated with the laser from the laser output unit 30 of the laser output device similar to the above-described embodiment, the surface of the insulating coating 24 at the end portion Zb can be carbonized. FIG. 6C is a diagram showing a state after the carbonization. After the carbonization is performed as described above, the stator is produced by performing the same steps as those in the above-described embodiment as steps after step S115.

The carbonization step may be a step of carbonizing the surface of the end portion of the insulating coating on the conductor side exposed by peeling. The end portion is a portion present at a boundary between the conductor and the insulating coating, and is, for example, a region having an area. The end portion may be a portion where the electrodeposited coating is to be formed overlapping the insulating coating, and is a region on the surface of the insulating coating that is large sufficient for the electrodeposited coating to be formed. The end portion is not limited to the region connecting the surface of the conductor and the surface of the insulating coating as in the above-described embodiment, and may be a narrower region or a wider region.

The coil arrangement step may be a step of arranging the coils on the stator core. The coils are electrically connected to each other by being welded to form a circuit. Then, the coils are wound around the stator core by being welded such that a plurality of coils are disposed on the teeth of the stator core. Therefore, the coil arrangement step may be a step of arranging the coils at predetermined positions of the stator core such that the coils can be welded to each other.

In the welding step, the conductors exposed by peeling in the plurality of coils may be welded to each other. That is, in the welding step, a predetermined circuit may be formed by welding the coils at predetermined positions. A plurality of pairs of coils to be welded may be present. The welding method is not limited, and various known methods such as laser welding and TIG welding can be adopted.

The electrodeposition coating step may be a step of performing the electrodeposition coating on the conductors exposed in the plurality of coils and the surface of the carbonized insulating coating using a resin material. That is, in the electrodeposition coating step, the conductors exposed by the peeling are covered with the electrodeposited coating (resin coating) made of the resin material. In addition, since the electrodeposited coating is also formed on the portion where the current flows along with the covering of the conductor, the electrodeposited coating is also formed on the carbonized surface of the insulating coating. Further, when there is a portion where the conductor is exposed by welding in a portion other than the surface of the coil, the electrodeposited coating is formed on the portion by a current flowing through the portion.

The carbonized portion is to be subjected to the electrodeposition coating. Therefore, the carbonized portion has electrical conductivity. Since the carbonized portion having the electrical conductivity is formed on the surface of the insulating coating, the electrodeposited coating can be formed on the surface of the insulating coating. Therefore, the carbonized portion may be formed so as to include a region where the electrodeposited coating needs to be formed. The electrodeposition coating is a method of forming a coating on a coating formation target portion by immersing the coating formation target portion in the solvent containing the water-soluble paint to be a coating and causing a current to flow between electrodes in the solvent. The method of the electrodeposition coating is not limited, and various known methods can be adopted. In addition, various materials can be adopted as the resin material constituting the electrodeposited coating, and examples thereof include a novolac type epoxy resin, a polyamide-imide resin, a polyimide resin, an acrylic resin, a polybutadiene resin, an alkyd resin, and a polyester resin.

According to an aspect of this disclosure, a method for producing a stator includes: a coil preparation step of preparing a coil in which an insulating coating is formed on a conductor; a stator core preparation step of preparing a stator core around which the coil is wound; an insulating coating peeling step of peeling off the insulating coating at a portion of the coil to be welded; a carbonization step of carbonizing a surface of an end portion of the insulating coating on a side facing the conductor exposed by the peeling; a coil arrangement step of arranging the coil on the stator core; a welding step of welding the conductors exposed by the peeling in a plurality of the coils; and an electrodeposition coating step of performing electrodeposition coating on the exposed conductor and the carbonized surface of the insulating coating in each of the plurality of coils using a resin material.

That is, the surface of the end portion of the insulating coating present at a boundary between the conductor exposed by the peeling and the insulating coating is carbonized, and the exposed conductor and the carbonized surface of the insulating coating are subjected to the electrodeposition coating. Since the carbonized portion is conductive, an electrodeposited coating is formed on the carbonized portion by the electrodeposition coating. As a result, even if the electrodeposited coating formed on a conductor portion is thin, the electrodeposited coating can be formed on the surface of the end portion of the insulating coating on the side facing the conductor exposed by the peeling. According to the above configuration, the electrodeposited coating reaching the insulating coating from the conductor portion beyond the boundary can be formed, and a possibility that the electrodeposited coating peels off from the insulating member can be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A method for producing a stator comprising:
a coil preparation step of preparing a coil in which an insulating coating (24) is formed on a conductor;
a stator core preparation step of preparing a stator core around which the coil is wound;
an insulating coating peeling step of peeling off the insulating coating at a portion of the coil to be welded;
a carbonization step of carbonizing a surface of an end portion of the insulating coating on a side facing conductor exposed by the peeling;
a coil arrangement step of arranging the coil on the stator core;
a welding step of welding the conductors exposed by the peeling in a plurality of the coils; and
an electrodeposition coating step of performing electrodeposition coating on the exposed conductor and the carbonized surface of the insulating coating in each of the plurality of coils using a resin material.

2. The method for producing a stator according to claim 1, wherein
the carbonization step includes carbonizing the surface of the insulating coating connecting a surface of the conductor and a surface of the insulating coating, at a boundary between the conductor exposed by the peeling and the insulating coating.

3. The method for producing a stator according to claim 2, wherein
the carbonization step includes carbonizing the surface of the insulating coating by irradiating the insulating coating with a laser.

4. The method for producing a stator according to claim 3, wherein
the insulating coating peeling step includes peeling off the insulating coating by irradiating the insulating coating with the laser, and
the laser used in the carbonization step and the insulating coating peeling step is continuously generated by the same device.

5. The method for producing a stator according to claim 1, wherein
the carbonization step includes carbonizing the surface of the insulating coating by irradiating the insulating coating with a laser.

6. The method for producing a stator according to claim 5, wherein
the insulating coating peeling step includes peeling off the insulating coating by irradiating the insulating coating with the laser, and
the laser used in the carbonization step and the insulating coating peeling step is continuously generated by the same device.

7. A stator comprising:
a coil; and
a stator core around which the coil is wound, wherein
the coil includes
a conductor,
an insulating coating covering a part of the conductor,
a carbonized portion of the insulating coating present on a surface of an end portion of the insulating coating on a side adjacent to the conductor, and
a resin coating formed on a surface of the conductor not covered with the insulating coating and a surface of the carbonized portion.

8. The stator according to claim 7, wherein
the resin coating is formed continuously from the surface of the carbonized portion to a surface of the insulating coating where the carbonized portion is not present.
